(19) United States
(12) Patent Application Publication
(10) Pub. No.: US 2004/0266931 A1
(43) Pub. Date: Dec. 30, 2004

(54) Polyamide and polyvinylbutyral compositions and blends comprising mineral filler and articles made therefrom

(76) Inventors: Win-Chung Lee, Parkersburg, WV (US); Avelino F. Lima, North Hills, WV (US); I-Chung W. Wang, Vienna, WV (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/799,056

(22) Filed: Mar. 12, 2004

Related U.S. Application Data
(60) Provisional application No. 60/454,889, filed on Mar. 14, 2003.

(51) Int. Cl. C08L 29/04

(52) U.S. Cl. 524/435; 524/502; 524/445; 524/451

(57) ABSTRACT

Polyamide compositions and blends toughened with polyvinylbutyral comprising from 10 to 45 wt % mineral filler are disclosed.

This application claims the benefit of U.S. Provisional Application No. 60/454,889, filed Mar. 14, 2003.

### FIELD OF THE INVENTION

The present invention relates to polyamide blends with polyvinylbutyral (PVB). More particularly, the present invention relates to such blends, processes for the manufacture of such materials, and molded articles prepared therefrom.

### BACKGROUND OF THE INVENTION

It is well known that toughening agents such as grafted rubbers can be employed to improve the toughness of polyamides. See generally, U.S. Pat. No. 4,174,358 assigned to E.I. DuPont de Nemours & Co. It is also known that mineral fillers can be incorporated into such polyamide blends to increase their stiffness. See, for example, U.S. Pat. No. 5,965,655; WO 0049081; U.S. Pat. No. 5,571,851; U.S. Pat. No. 4,795,768; U.S. Pat. No. 4,740,538; U.S. Pat. No. 4,399,246; and U.S. Pat. No. 3,419,517. It is also well known that plasticized polyvinylbutyral can be used as a toughener in, for example, 6-nylon. See generally, U.S. Pat. No. 5,770,654 also assigned to E.I. DuPont de Nemours & Co and directed to such compositions suitable for a variety of applications where good toughness is required, as in packaging subjected to rough handling. As used herein polyvinylbutyral is abbreviated as “PVB”.

Plasticized PVB can be difficult to handle as a feed to a compounding extruder due to its inherent stickiness. Similarly PVB sheet is a material that can be difficult to work with because of the tendency to adhere to itself. Sheets of PVB can stick together, or bind, with such strength that it is very difficult to separate the layers. The irreversible nature of this self-adhesion by PVB is referred to in the art of PVB manufacture as “blocking”. Once PVB “blocks”, process difficulties are encountered. This tendency to block can make manufacturing processes that incorporate PVB unnecessarily complex and difficult. Consequently, continuous processes in which PVB is handled either in sheet form or in small shredded pieces can be very expensive to run, and therefore are not practical.

Moreover, blends of PVB sheet or small shredded pieces with other materials can block in the same manner as homogenous PVB compositions. Such blends of PVB with other polymers can be difficult to obtain in a cost-effective manner. A preferred process for preparing blends of PVB with other polymers would utilize conventional loss-in-weight screw feeders, which are found throughout that industry.

Recent work in the field indicates that blends of PVB with polyethylene and grafted rubbers are sufficiently non-sticky that they can be fed into a compounding extruder. See for example, WO 02/12356 directed to a process for preparing pellets from PVB scrap material.

It is an object of the present invention to provide PVB-toughened polyamide compositions that are mineral-filled.

### SUMMARY OF THE INVENTION

In one aspect, the present invention is a thermoplastic polyamide composition comprising: (a) from about 5 to about 30 weight percent of a free-flowing toughener comprising from about 20 weight percent to about 95 weight percent polyvinyl butyral;

(b) complimentally, 95 to 25 weight percent polyamide that is melt processible below about 320° C. and a number average molecular weight of at least 5,000; (c) a mineral filler in an amount of from about 10 to about 45 weight percent of the total composition; and (d) optionally a coupling agent.

In another aspect, the present invention is an article comprising a thermoplastic polyamide composition comprising: (a) from about 5 to about 30 weight percent of a free-flowing toughener comprising from about 20 weight percent to about 95 weight percent polyvinyl butyral; (b) complimentally, 95 to 25 weight percent polyamide that is melt processible below about 320° C. and a number average molecular weight of at least 5,000; (c) a mineral filler in an amount of from about 10 to about 45 weight percent of the total composition; and (d) optionally a coupling agent.

### DETAILED DESCRIPTION OF THE INVENTION

In one embodiment, the present invention is a toughened polyamide composition comprising a mineral filler. A composition of the present invention comprises a free-flowing PVB composition as a toughener, as described in WO 0212356, incorporated herein by reference. A composition of the present invention comprises from about 5 wt % to about 30 wt %, preferably from about 5 wt % to about 28 wt %, more preferably from about 6 wt % to about 25 wt %, and most preferably from about 7 wt % to about 25 wt % of a free-flowing PVB composition. The toughener comprises from about 20 to about 95 wt %, preferably from about 40 wt % to about 95 wt %, more preferably from about 60 wt % to about 95 wt %, and most preferably from about 75 wt % to about 95 wt % PVB. The compositions and blends of this invention are typically prepared by production of a free-flowing toughener followed by blending of that toughener with nylon, a coupling agent, and other ingredients to produce a toughened polyamide blend having enhanced surface properties.

The toughener comprises at least one component in addition to the PVB. Such other components can be monomeric or polymeric materials, or mixtures thereof. The other components can be selected from polymers and/or monomers that have reactive functionality, or non-reactive polymer and/or monomers such as, for example, polyethylene, polypropylene, polyvinylchloride, nylon, other thermoplastic materials, or mixtures thereof. Preferably the second component is a polymer composition that includes reactive functionality such as anhydride functionality, such as is available commercially from E. I. DuPont de Nemours and Company under the Fusabond® brand name, or carboxylic acid functionality. Fusabond® polymers are polyolefins having anhydride functionality. The other components are present in the toughener in amounts that are complimentary to the amount of PVB in the toughener, that is to bring the total percentage of PVB and other component(s) to 100 wt %.

The polyamide can be any amorphous or crystalline polyamide as described in U.S. Pat. No. 5,770,654, for example. Preferably, the polyamide is melt processible below a temperature of about 320° C. and has a number average molecular weight of at least 5,000. The polyamide component can be present in an amount of from about 25 wt % to about 95 wt %. Preferably, the polyamide component is present in an amount of from about 30 wt % to about 90 wt %, more preferably from about 40 wt % to about 90 wt %, most preferably from about 50 wt % to about 90 wt %.

Fillers can be present in an amount of from about 10 to about 45 wt %. Suitable mineral fillers are, for example, calcined clay, metal carbonates, titanium dioxide, wollastonite, or talc. An antioxidant is not required, however one is preferred. If included, the antioxidant can be present in an amount of at least about 0.1% by weight, and up to an amount where the effect of the antioxidant is optimal.

A coupling agent is optionally included in the composition of the present invention. The coupling agent can increase the tensile strength, notched Izod and flexural modulus of the polyamide composition. The coupling agent can be a silane compound. Preferably the coupling compound is selected from the group consisting of: gamma-Aminopropyltrimethoxysilane; gamma-aminopropyltriethoxysilane; N-2 -aminopropyltrialkoxysilane; or N-(2-aminoethyl)-3-aminopropylmethyldialkoxysilane. The coupling compound can be present in an amount of at least about 0.01 wt %. Preferably, the coupling agent is present in an amount of from about 0.1 to about 3 wt %. More preferably, the coupling agent is present in an amount of from about 0.3 wt % to about 2.0 wt %, and most preferably in an amount of from about 0.5 wt % to about 1.5 wt %.

In another embodiment, the present invention is a process for preparing the toughened polyamide compositions of the present invention. The toughener of the present invention can be obtained using the process described in WO 0212356. PVB is a commercially available product useful for imparting shatter-resistance to glass in myriad applications, among them windshields for automobiles and window glass in homes and buildings. The preparation of PVB is a well-known reaction between aldehyde and alcohol in an acid medium. The plasticizer used is also a commercially available chemical such as diester of aliphatic diols with aliphatic carboxylic acids, e.g. tri-ethylene glycol di-2-ethylhexoate (3GO), or tetra-ethylene glycol di-n-heptanoate (4G7). Virgin plasticized PVB sheets (virgin plasticized PVB, as the term is used herein, shall mean PVB that is obtained first-hand from a manufacturer's roll) can be obtained commercially from DuPont under the brandname of BUTACITE®, for example. PVB can be obtained from other sources, as well, including excess PVB obtained from the edge trim from safety or architectural glass manufacturing operations, PVB recovered from scrap automotive or architectural glass, PVB not considered usable in other commercial applications, and other similar sources or mixtures of these sources. Any of these sources can be satisfactorily used without departing from the spirit and scope of this invention.

In a preferred embodiment, the present invention is a process wherein plasticized PVB and three other ingredients (a reactive polymer such as Fusabond®, a non-reactive polymer such as polyethylene, polypropylene, or ethylene/n-butyl, and an antioxidant) are (1) mixed in a batch process or a continuous process, (2) formed into a sheet, (3) re-melted (4) filtered in the melt, and (5) made into pellets.

For example, mixing can be conducted at an elevated temperature in the range of from about 100° C. to about 280° C., preferably from about 150° C. to about 220° C. to provide a homogeneous melt blend. The blend obtained from the mixing procedure can be transferred by some means to a set of roll mills for additional mixing and to press the blend into a sheet form. A strip of the sheet can be fed either continuously or by a batch process to an extruder, but preferably the sheet is continuously fed using, for example, a belt feeder. Once inside the extruder, the sheet is melted and the melt is filtered to remove solid contamination. The polymer can be pelletized by any known or conventional method. For example, the filtered melt can be distributed to a die wherein the die has multiple holes. In such a process the melt exits the die at the die face, which can be positioned just above the surface of the water in a tank filled with water, or submerged under the surface of the water to quickly cool (quench) the melt as it exits the die. An under water face cutter can be used to cut the polymer exiting the die face to form pellets. The water quenches the pellets and carries them to a filter screen to separate them from the bulk water. The wet pellets can be dried, for example in a fluidized dryer, before they are packed.

The pellets thus obtained can be mixed by melt-blending with suitable polyamide compositions, as described in U.S. Pat. No. 5,770,654, herein incorporated by reference. For example, the toughened polyamide blends suitable for use herein can be obtained by melt blending, or melt mixing in any suitable blending or mixing device, such as a Banbury blenders, Haake mixers, Farrell mixers, or extruders. Extruders can be either single screw or twin screw extruders with screws having various degrees of severity. Mixing or blending can be done at a temperature in the range of from about 200° C. to about 320° C., and preferably at a temperature in the range of from about 230° C. to about 300° C. The blends can be palletized by any known conventional method. Preferably pellets are formed by cutting extruded strands of the blend.

Toughened polyamides having enhanced adhesive properties can be obtained by further incorporating an optional coupling or crosslinking agent with the toughened polyamide. For example, a coupling agent such as Silquest A-1100™ (gamma-aminopropyltriethoxysilane), which is commercially available from General Electric, can be incorporated by either inclusion into the bulk of the toughened polyamide composition, or by coating the surface of the toughened polyamide composition. The coupling compound can be incorporated in either manner as an aqueous solution. The pH of the solution can be lowered using an acid such as acetic acid or citric acid, for example.

In another embodiment, the present invention is an article obtained from the polyamide compositions of the present invention. Articles of the present invention include laminate articles, shaped articles, etc. Laminates comprising the polyamide compositions of the present invention can be incorporated into various other articles such as, for example, toys, furniture, cars, trains, automobiles, appliances, boats, acoustic tiles, acoustic flooring, walls, ceilings, roofs, roofing materials or other articles where sound damping and/or tough polymers are desirable. Laminates of the present invention are not readily transparent to visible light.

In a particularly preferred embodiment, the rigid polyamide compositions of the present invention can be laminated to other polymeric materials such as, for example, thermoplastic elastomers (TPEs). TPEs are thermoplastic materials that have rubber-like properties and are soft to the touch. However, TPEs do not generally have good adhesion to conventional rigid polymers. The polyamide compositions of the present invention can eliminate this adhesion problem and provide suitable laminates with TPEs in many cases.

In another preferred embodiment, the polyamide compositions of the present invention can be laminated with PVB to yield PVB laminates having substantial sound reduction properties. Such laminates can find usefulness in applications where sound reduction is important such as, for example: automobile engine compartments; appliances such as washing machines; dryers; refrigerators; air conditioners; furnaces; and similar devices that can create loud noise when in use.

In still another embodiment, laminates having at least two sheets comprising a polyamide composition of the present invention adhered on the opposite surfaces of a PVB interlayer have improved and structural strength relative to one sheet of the polyamide having twice the thickness of the laminate polyamide sheets. Such laminates can find use in: various parts of an automobile such as the door panels, trunk, hood, floorboard; boat hulls; shipping crates; or other similar uses to impart structure and strength.

### EXAMPLES

### Examples 1 to 4 and Control Examples C1 and C2

The free flowing PVB prepared according to the procedure described in WO 0212356 using “ECOCITE™” which is commercially available from E.I. DuPont de Nemours and Company (DuPont), was melt blended together with either Zytel® 101(available commercially from DuPont) or Ultramid® B3 (available commercially from BASF) and mineral (Translink™ HF900, available commercially from Englehard). During the operation for melt blending the ingredients were primarily fed through individually controlled loss in weight feeders. The mixture was compounded by melt blending in a 40 mm Werner & Pfleiderer co-rotating twin screw extruder with a barrel temperature about 280° C. and a die temperature of about 290° C. All the ingredients were fed into the first barrel section except the mineral, which was fed into the sixth barrel section by use of a side feeder. Extrusion was carried out with a port under vacuum. The screw speed was 250 rpm and the total extruder feed rate was 120 pounds per hour. Percent torque on the screw motor was measured and recorded.

The resulting strand was quenched in water, cut into pellets, and sparged with nitrogen until cool. The moisture in the resulting pellets was adjusted to between 0.1% and 0.2% by drying or adding additional water as required. Test bars were molded in an injection molding machine-according to ISO Method 294. The molded bars were tested in their dry-as-molded state. The bars were tested for: impact—notched Izod (NI), un-notched Izod (UNI); Tensile strength —elongation at break (TS EL-B), break (TS-B), yield (TS-Y); Flexural Modulus (Flex Mod); and Torque. All data are shown in Table 1.

Various amounts of ECOCITE™ Grade H were used in Examples 1 to 4. For Example 4, a fourth additive was used: Fusabond® A MG-423D (Ethylene/alkyl acrylate/CO 25 copolymer modified with 1% maleic anhydride graft available commercially from DuPont).

Some literature values of a commercial mineral filled Nylon 66 (Minlon® 10B40 available commercially from DuPont) have been included in Table 1 as example C1 for comparison. In addition, the same system and test methods described above for Examples 1 to 4 were used for control example C2 without any ECOCITE™ Grade H and Fusabond® A MG-423D.

TABLE 1
Effect of ECOCITE ™ on Mineral Filled Polyamide

| Example # | C1 | C2 | Exp 1 | Exp 2 | Exp 3 | Exp 4 |
|---|---|---|---|---|---|---|
| Zytel ® 101 | — | 60 | 51 | 48 | 42 | 42 |
| ECOCITE ™ H (Wt %) | — | | 9 | 12 | 18 | 9 |
| Translink ® HF900 | — | 40 | 40 | 40 | 40 | 40 |
| Fusabond ® A MG423D | — | — | — | — | — | 9 |
| Melt Viscosity @ | — | 1729 | 1297 | — | 875 | 1614 |
| 280° C./2487 s⁻¹ (Pa-s) | | | | | | |
| NI @ 23° C. (kJ/m²) | 3.98 | 5.56 | 5.7 | 6.0 | 5.7 | 7.1 |
| NI @ 23° C. (J/m) | 32 | 44.5 | 45.8 | 48.7 | 45.7 | 57.0 |
| NI @ −30° C. (kJ/m²) | 3.98* | | 5.2 | 5.2 | 5.0 | 6.5 |
| NI @ −30° C. (J/m) | 32 | | 41.8 | 42.7 | 40.4 | 53.1 |
| UNI @ 23° C. (kJ/m2) | | 65.05 | 32.4 | 41.8 | 50.4 | 73.7 |
| UNI @ 23° C. (J/m) | | | 330.5 | 426.6 | 508.8 | 752.7 |
| TS EL-B (%) | 3 | 2.88 | 4.9 | 6.5 | 8.7 | 10.1 |
| TS-B (Mpa) | 98 | 86.76 | 65.1 | 55.7 | 44.2 | 40.7 |
| TS-B (psi) | 14200 | 12591.9 | 9451 | 8078 | 6416 | 5902 |
| TS-Y (Mpa) | | 86.77 | 65.1 | 55.6 | 44.1 | 40.5 |
| TS-Y (psi) | | 12592.9 | 9445 | 8067 | 6398 | 5878 |
| Flex Mod (Gpa) | 7.24 | 4.951 | 4.43 | 3.93 | 2.71 | 3.02 |
| Flex Mod (psi) | 1050000 | 718577 | 642169 | 569706 | 392668 | 438044 |
| Torque (%) | | 63 | 53 | 50 | 43.4 | 52.3 |

*@ −40° C.

The toughness as measured by NI23° C. and NI-30° C. (notched izod measured at 23° C. and −30° C., respectively) increases while the percent of torque in the extruder and melt viscosity at 280° C. and 2487 sec⁻¹ decrease as ECOCITE™ Grade H and combination of ECOCITE™ Grade H and Fusabond® A MG-423D are added in the blends.

### Examples 5 to 8

The same process and procedures in above Examples 1 to 4 were used for Examples 5 to 8 except that Zytel®101 was pre-blended with Silquest® A-1100 before feeding to the extruder.

TABLE 2
Effect of Saline on ECOCITE ™ Blends with Mineral Filled Polyamide

| | Ex 5 | Ex 6 | Ex 7 | Ex 8 |
|---|---|---|---|---|
| Zytel ® 101 | 51 | 48 | 42 | 42 |
| Silane Sil- | 0.2 | 0.2 | 0.2 | 0.2 |
| quest ® A1100 | | | | |
| ECOCITE ™ | 9 | 12 | 18 | 9 |
| H (Wt %) | | | | |
| Fusabond ® | — | — | — | 9 |
| A MG423D | | | | |
| Translink ® | 40 | 40 | 40 | 40 |
| HF900 | | | | |
| Melt Viscos- | 2337 | 2124 | 1860 | 2125 |
| ity @ 280° C./ | | | | |
| 2487 s⁻¹ (Pa-s) | | | | |
| NI @ 23° C. | 3.86 | 4.66 | 3.76 | 4.26 |
| (kJ/m²) | | | | |
| NI @ 23° C. | 30.71 | 37.1 | 30.03 | 34.2 |
| (J/m) | | | | |
| NI @ −30° C. | 60 | 59.23 | 48.39 | 47.98 |
| (kJ/m²) | | | | |
| NI @ −30° C. | 601.22 | 592.93 | 484.39 | 480.73 |
| (J/m) | | | | |
| UNI @ 23° C. | 5.6 | 4.455 | 6.204 | 8.33 |
| (kJ/m2) | | | | |
| UNI @ 23° C. | 77.868 | 70.48 | 66.237 | 39.539 |
| (J/m) | | | | |
| TS EL-B (%) | 11301.635 | 10229.343 | 9613.563 | 5738.618 |
| TS-B (Mpa) | 77.947 | 70.56 | 66.298 | 39.6 |
| TS-B (psi) | 11313.104 | 10240.886 | 9622.41 | 5747.502 |
| TS-Y (Mpa) | 6.228 | 5.664 | 5.778 | 3.354 |
| TS-Y (psi) | 903983 | 822127 | 838608 | 486765 |
| Flex Mod | 54 | 57 | 58 | 61 |
| (Gpa) | | | | |

SEM (Scanning Electronic Microscopy) Pictures of Example 7

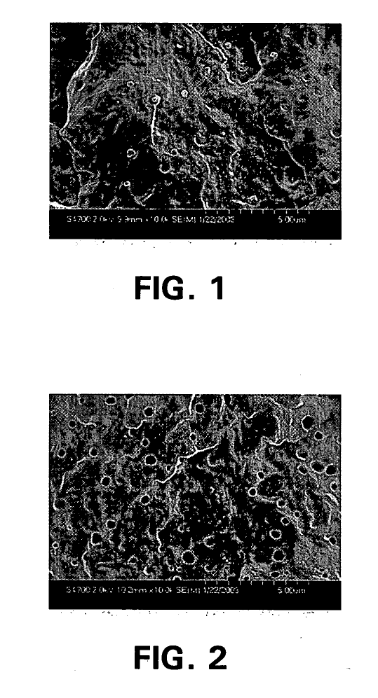

The polymer of Example 7 was examined by SEM before and after exposure of the polymer surface to methanol vapor in order to extract PVB. The size of the PVB dispersed in the polymer matrix was less than 0.5 micrometer as shown in the following SEM pictures of the cross section of a fractured tensile bar. The tensile bar was made from material of Example 7 and was cooled with liquid nitrogen before fracture. FIG. 1 is before methanol extraction and FIG. 2 is after methanol extraction.

What is claimed is:

1. A thermoplastic polyamide composition comprising: (a) from about 5 to about 30 weight percent of a free-flowing toughener comprising from about 20 weight percent to about 95 weight percent polyvinyl butyral; (b) complimentally, 95 to 25 weight percent polyamide that is melt processible below about 320° C. and a number average molecular weight of at least 5,000; (c) a mineral filler in an amount of from about 10 to about 45 weight percent of the total composition; and (d) optionally a coupling agent.

2. The composition of claim 1 wherein the toughener comprises one or more polymers having anhydride functionality and one or more polymers having carboxylic acid functionality.

3. The composition of claim 1 wherein the toughener additionally comprises a non-reactive polymer.

4. The composition of claim 3 wherein the non-reactive polymer is selected from the group consisting of polyethylene, polypropylene, polyvinylchloride, nylon, olefinic copolymers, and mixtures thereof.

5. The composition of claim 1 wherein the filler is a mineral selected from the group consisting of calcined clay, metal carbonates, titanium dioxide, wollastonite, or talc.

6. The composition of claim 1 comprising a coupling agent wherein the coupling agent is an aminosilane compound and is included in an amount of from about 0.1 to about 1 wt %.

7. The composition of claim 1 wherein the polyamide is selected from the group consisting of Nylon 6; Nylon 11; Nylon 12; Nylon 66; Nylon 6, 10;
Nylon 12, 12; and copolymers of epsilon-caprolactam with hexamethylenediamine and adipic acid.

8. An article prepared from the composition of claim 1.

9. The article of claim 8 wherein the article is selected from articles in the group consisting of:
toys; furniture; cars; trains; automobiles; appliances;
boats; acoustic tiles; acoustic flooring; walls;
ceilings; roofs; and, roofing materials.
